(19) United States
(12) Patent Application Publication
(10) Pub. No.: US 2014/0362601 A1
(43) Pub. Date: Dec. 11, 2014

(54) LASER BACKLIGHT PLATE

(71) Applicant: NATIONAL TAIPEI UNIVERSITY of TECHNOLOGY, Taipei City (TW)

(72) Inventor: Wei-Feng HSU, Taipei City (TW)

(21) Appl. No.: 14/301,324

(22) Filed: Jun. 10, 2014

(30) Foreign Application Priority Data
Jun. 11, 2013 (TW) 102120745

(51) Int. Cl. F21V 8/00

(52) U.S. Cl. CPC G02B 6/0025
USPC 362/609

(57) ABSTRACT

A laser backlight plate includes a laser source, a light guide plate, least one reflective layer, and at least one light divergent structure. The laser source is configured for providing a laser beam. The light guide plate has a light emission surface, a backlight surface, and at least one side surface. The backlight surface is disposed opposite to the light emission surface, and the side surface extends between the light emission surface and the back light surface. The reflective layer at least partially covers the backlight surface and the side surface, and is configured for reflecting the laser beam impinging on the reflective layer to the light emission surface. The light divergent structure is configured for diffusing the laser beam, which is incident on the light guide plate from the light divergent structure, and is reflected to the light emission surface by the reflective layer.

### RELATED APPLICATIONS

This application claims priority to Taiwan Application Serial Number 102120745, filed Jun. 11, 2013, which is herein incorporated by reference.

### BACKGROUND

1. Field of Invention

The present invention relates to a laser backlight plate.

2. Description of Related Art

At present, a side-edge backlight module mostly adopts lamp tubes or light emitting diodes as light sources. The light emitted from the lamp tube or the light emitting diode enters a light guide plate from the side surface thereof, such that the intensity of the light guide plate attenuates along the transversal direction of the light guide plate away from the lamp tube or the light emitting diode. In this regard, the light efficiency of the side-edge backlight plate with the lamp tube or the light emitting diode is low and thus not suitable for a backlight source of a large-sized panel. In addition, since the light emitted from the lamp tube or the light emitting diode has a specific bandwidth, the color saturation of the mixed light of the backlight plate is limited in the improvement of the backlight plate quality. Moreover, in that the light emitted from the lamp tube or the light emitting diode has a large divergent angle, the thickness of the backlight plate has to be increased to prevent light leakage.

### SUMMARY

An aspect of the present invention is to provide a laser backlight plate including a laser source, a light guide plate, at least one reflective layer, and at least one light divergent structure. The laser source is configured for providing a laser beam. The light guide plate has a light emission surface, a backlight surface, and at least one side surface. The backlight surface is disposed opposite to the light emission surface, and the side surface extends between the light emission surface and the back light surface. The reflective layer at least partially covers the backlight surface and the side surface, and is configured for reflecting the laser beam impinging on the reflective layer to the light emission surface. The light divergent structure is configured for diffusing the laser beam. The laser beam is incident on the light guide plate from the light divergent structure, and is reflected to the light emission surface by the reflective layer.

In one or more embodiments, the light divergent structure is disposed on the side surface of the light guide plate, and the light divergent structure is a recess.

In one or more embodiments, the recess has a divergent surface, and the divergent surface is a curved surface.

In one or more embodiments, the light divergent structure is a diffractive optical element.

In one or more embodiments, the diffractive optical element is disposed on the side surface of the light guide plate.

In one or more embodiments, an acute angle is formed between the light emission surface and the side surface. The diffractive optical element is disposed at an end of the light emission surface adjacent to the side surface The laser beam of the laser source passes through the diffractive optical element and enters the light guide plate, and the laser beam propagates in the light guide plate after being reflected by the reflective layer disposed on the side surface.

In one or more embodiments, an acute angle is formed between the light emission surface and the side surface. The diffractive optical element is disposed at an end of the light emission surface adjacent to the side surface, and the reflective layer exposes a portion of the side surface. The laser beam of the laser source passes through the diffractive optical element and enters the light guide plate, and the laser beam propagates in the light guide plate after being reflected by the exposed side surface.

In one or more embodiments, an acute angle is formed between the backlight surface and the side surface. The reflective layer exposes an end of the backlight surface adjacent to the side surface, and the diffractive optical element is disposed at the end of the backlight surface adjacent to the side surface. The laser beam of the laser source passes through the diffractive optical element and enters the light guide plate, and the laser beam propagates in the light guide plate after being reflected by the reflective layer disposed on the side surface.

In one or more embodiments, an acute angle is formed between the backlight surface and the side surface. The reflective layer exposes a portion of the side surface and an end of the backlight surface adjacent to the side surface, and the diffractive optical element is disposed at the end of the backlight surface adjacent to the side surface. The laser beam of the laser source passes through the diffractive optical element and enters the light guide plate, and the laser beam propagates in the light guide plate after being reflected by the exposed side surface.

In one or more embodiments, the diffractive optical element includes a plurality of microstructures.

In one or more embodiments, the microstructures are arranged periodically.

In one or more embodiments, the laser backlight plate further includes at least one guiding element disposed between the laser source and the light divergent structure. The guiding element is configured for guiding the laser beam to the light divergent structure.

The laser backlight plate mentioned above uses the laser source as a light source, and uses the light divergent structure to diffuse the laser beam, such that the laser backlight plate can reduce energy consumption, enhance color saturation, increase the area of the light guide plate, and reduce the thickness of the light guide plate. Moreover, since the guiding element separates the laser source and a light emitting element, which is the light guide plate, the safety of the laser backlight plate can be enhanced.

### BRIEF DESCRIPTION OF THE DRAWINGS

FIG. 1A is a top view of a laser backlight plate according to the first embodiment of the present invention;

FIG. 1B is a cross-sectional view taken along line A-A of FIG. 1A;

FIG. 2A is an enlarged perspective diagram of a laser backlight plate according to the second embodiment of the present invention;

FIG. 2B is a top view of the laser backlight plate of FIG. 2A;

FIG. 2C is a cross-sectional view taken along line B-B of FIG. 2B;

FIG. 3A is a top view of a laser backlight plate according to the third embodiment of the present invention;

FIG. 3B is a top view of a laser backlight plate according to the fourth embodiment of the present invention;

FIG. 4 is a top view of a laser backlight plate according to the fifth embodiment of the present invention;

FIG. 5A is a top view of a laser backlight plate according to the sixth embodiment of the present invention;

FIG. 5B is spatial distribution and intensity distribution diagrams of the diffractive light beams of FIG. 5A;

FIG. 6A is a schematic diagram of a diffractive optical element of FIG. 5A according to one embodiment;

FIG. 6B is a schematic diagram of the diffractive optical element of FIG. 5A according to another embodiment;

FIGS. 7A and 7B are top views of laser backlight plates according to the seventh and eighth embodiments of the present invention, respectively;

FIG. 8 is a top view of a laser backlight plate according to the ninth embodiment of the present invention;

FIGS. 9A and 9B are cross-sectional views of laser backlight plates according to the tenth and eleventh embodiments of the present invention; and

FIGS. 10A and 10B are cross-sectional views of laser backlight plates according to the twelfth and thirteenth embodiments of the present invention.

### DETAILED DESCRIPTION

Reference is now made in detail to the present embodiments of the invention, examples of which are illustrated in the accompanying drawings. Wherever possible, the same reference numbers are used in the drawings and the description to refer to the same or like parts.

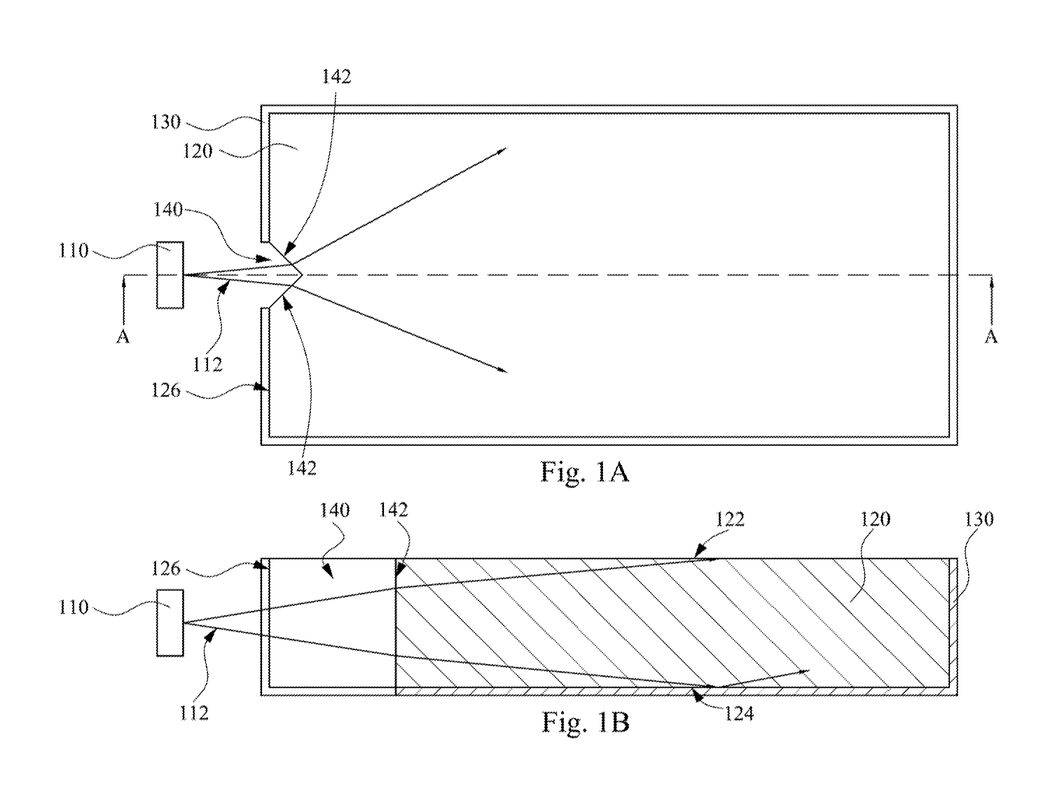

FIG. 1A is a top view of a laser backlight plate according to the first embodiment of the present invention, and FIG. 1B is a cross-sectional view taken along line A-A of FIG. 1A. The laser backlight plate includes a laser source 110, a light guide plate 120, at least one reflective layer 130, and at least one light divergent structure (a recess 140 in this embodiment). The laser source 110 is configured for providing a laser beam 112. The light guide plate 120 has a light emission surface 122, a backlight surface 124, and at least one side surface 126. The backlight surface 124 is disposed opposite to the light emission surface 122, and the side surface 126 extends between the light emission surface 122 and the back light surface 124. The reflective layer 130 at least partially covers the backlight surface 124 and the side surface 126. For example, the reflective layer 130 covers entire of the backlight surface 124 and the side surface 126. The reflective layer 130 is configured for reflecting the laser beam 112 impinging on the reflective layer 130 to the light emission surface 122. The recess 140 is disposed on the light guide plate 120, and the recess 140 is configured for diffusing the laser beam 112. The laser beam 112 is incident on the light guide plate 120 from the recess 140, and is reflected to the light emission surface 122 by the reflective layer 130. Accordingly, since the laser backlight plate of the present embodiment provides laser beam 112 by the laser source 110, and the recess 140 diverges the laser beam 112, the laser backlight plate reduces energy consumption, enhances color saturation, increases the area of the light guide plate 120, and reduces the thickness of the light guide plate 120.

In greater detail, the laser source 110 such as a laser diode can reduce the energy consumption of the laser backlight plate since the luminous efficiency of the laser source 110 is higher than that of a light emitting diode or a lamp. In addition, the high collimation of the laser beam 112 provides longer propagation distance than that of a light beam emitted from the light emitting diode. Also, since the angle of a laser beam 112 diverges less than that of the light beam emitted from the light emitting diode, the laser beam 112 can be applied to the laser backlight plate which has larger size and smaller thickness. After passing through the recess 140, the laser beam 112 has a specific divergent direction according to the structure of the recess 140, such that the laser beam 112 can be uniformly and efficiently distributed in the light guide plate 120. In other words, due to the combination of the laser source 110 and the recess 140, the laser backlight plate of the present embodiment can achieve uniformly distributed light with less laser sources 110. Furthermore, since the laser beam 112 has high color purity due to its single frequency (or ultra-narrow frequency) property, the laser sources 110 providing different colors (such as red, green, and blue) can be applied to the laser backlight plate to achieve high color saturation by mixing the laser sources 110.

In this embodiment, the recess 140 is disposed on the side surface 126 of the light guide plate 120, and the recess 140 has two divergent surfaces 142. Although the laser beam 112 is highly collimated compared with light emitting diodes, in reality, the laser beam 112 has a small divergent angle and a beam cross section (see FIG. 1), such that the laser beam 112 can impinge on the two divergent surfaces 142 simultaneously. After entering the light guide plate 120 at the recess 140 of the divergent surfaces 142, the laser beam 112 further diverges due the deflection at the divergent surfaces 142. In other words, in the light guide plate 120, the laser beam 112 propagates with a larger divergent angle so as to uniformly distribute in the light guide plate 120.

In one or more embodiments, the light guide plate 120 can further contain a plurality of micro-particle structures for scattering the laser beam 112. The micro-particle structures can be formed on the backlight surface 124 of the light guide plate 120 using pattering or coating (adhering) process. If the light guide plate 120 has the micro-particle structures, the divergent surfaces 142 can be designed to guide the laser beam 112 toward the backlight surface 124 for increasing the scattering of the laser beam 112. In the embodiment of FIG. 1B the divergent surfaces 142 can optionally slant downwards, such that the laser beam 112 can propagate toward the backlight surface 124. However, the claimed scope of the invention should not be limited in this respect.

In one or more embodiments, the light guide plate 120 can be made of transparent or translucent materials such as glasses, plastic, or polymethylmethacrylate (PMMA). Moreover, even though the light guide plate 120 in FIG. 1A is rectangular-shaped, in other embodiments, the shape of the light guide plate 120 can be different, such as a circle or a polygon, according to real requirements.

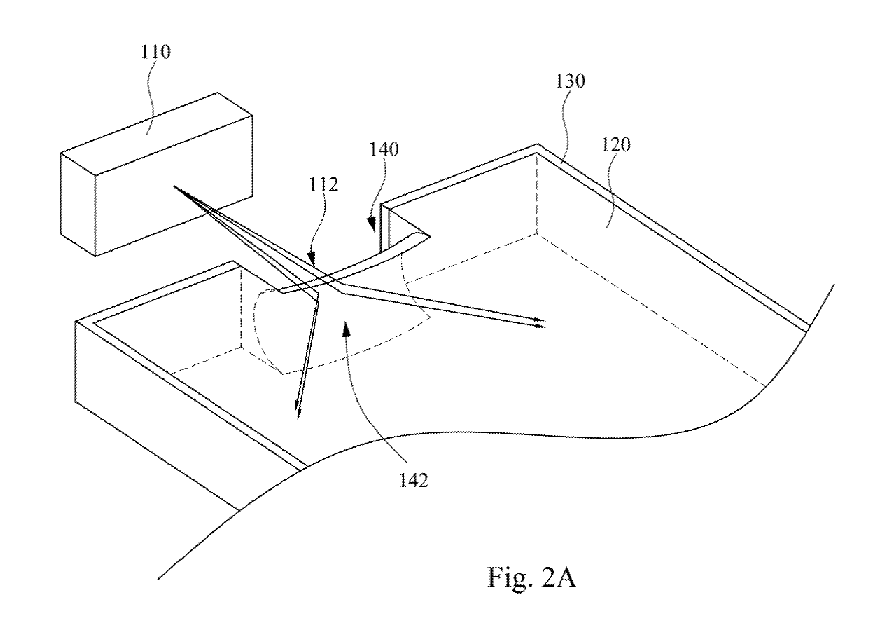

FIG. 2A is an enlarged perspective diagram of a laser backlight plate according to the second embodiment of the present invention, and FIG. 2B is a top view of the laser backlight plate of FIG. 2A. The difference between the second embodiment and the first embodiment pertains to the number and the shape of the divergent surfaces 142 of the recess 140. In this embodiment, the divergent surface 142 is a curved surface.

In this embodiment, with respect to the top view of FIG. 2B, the divergent surface 142 is a surface curved toward the light guide plate 120, such that the combination of the divergent surface 142 and the light guide plate 120 can be regarded as a concave lens. The divergent angle of the laser beam 112 increases as the laser beam 112 passes through the divergent surface 142 due to the curved structure of the divergent surface 142 and deflection. Hence, the laser beam 112 can be efficiently and uniformly distributed in the light guide plate 120 through the divergent surface 142.

Reference is made to FIG. 2C which is a cross-sectional view taken along line B-B of FIG. 2B. Based on the above, the laser beam 112 has a small divergent angle along a vertical direction, which is defined as a direction perpendicular to the light emission surface 122. For reducing the thickness of the light guide plate 120, as shown along the side view,the divergent surface 142 can be a surface curved toward to the laser source 110, such that the combination of the divergent surface 142 and the light guide plate 120 can be regarded as a convex lens. The divergent angle of the laser beam 112 decreases as the laser beam 112 passes through the divergent surface 142 due to the curved structure of the divergent surface 142 and deflection. Hence, the light guide plate 120 of a smaller thickness can be adopted.

Similarly, in one or more embodiments, when the backlight surface 124 of the light guide plate 120 includes the micro-particle structures, the divergent surface 142 can be a curved surface to guide the laser beam 112 to the backlight surface 124 for increasing the scattering of the laser beam 112. For example, the curvature of the divergent surface 142 is not symmetric with respect to the central surface between the light emission surface 122 and the backlight surface 124 as shown in FIG. 2C. Instead, the curved center of the divergent surface 142 is close to the light emission surface 122, such that the laser beam 112 can propagate toward the backlight surface 124. Other relevant details of structure of the second embodiment are all the same as the first embodiment and, therefore, a description in this regard will not be repeated hereinafter.

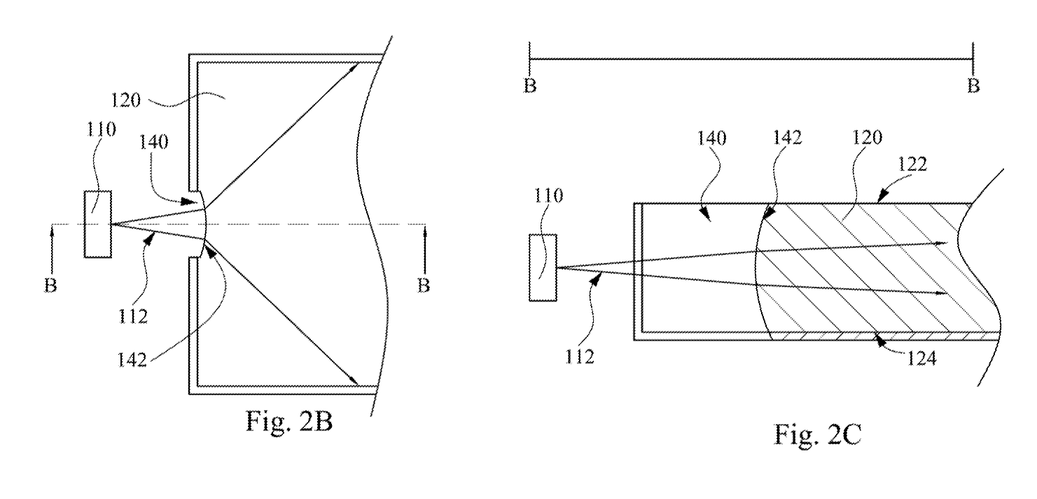

Reference is made to FIG. 3A which is a top view of a laser backlight plate according to the third embodiment of the present invention. The difference between the third embodiment and the first embodiment pertains to the numbers of the laser sources 110 and the recesses 140. In this embodiment, more than one laser source 110 and the recess 140 can be used to increase the intensity of the laser backlight plate. For example, if the light guide plate 120 is a rectangular plate, the laser sources 110 and the recesses 140 can be disposed on the four side surfaces 126 of the light guide plate 120. Hence, the laser beams 112 can be split and pass through the recesses 140 disposed on the four side surfaces 126 to enter the light guide plate 120. Therefore, the intensity of the laser backlight plate of the present embodiment is four times the intensity of the laser backlight plate of the first embodiment. Other relevant details of structure in the third embodiment are all the same as the first embodiment and, therefore, a description in this regard will not be repeated hereinafter.

Reference is made to FIG. 3B which is a top view of a laser backlight plate according to the fourth embodiment of the present invention. The difference between the fourth embodiment and the third embodiment pertains to the positions of the laser sources 110 and the recesses 140. In this embodiment, the light guide plate 120 is a rectangular plate, and the laser sources 110 and the recesses 140 are disposed at four corners of the light guide plate 120. Hence, the laser beams 112 can be split and pass through the recesses 140 disposed at the four corners to enter the light guide plate 120. Other relevant details of the structure of the fourth embodiment are all the same as the third embodiment and, therefore, a description in this regard will not be repeated hereinafter.

It is noted that the numbers and the positions of the light sources 110 and the recesses 140 of the third and the fourth embodiments are used for illustration only and should not limit the claimed scope of the present invention. A person having ordinary skill in the art may choose suitable numbers and the positions of the light sources 110 and the recesses 140 according to real requirements.

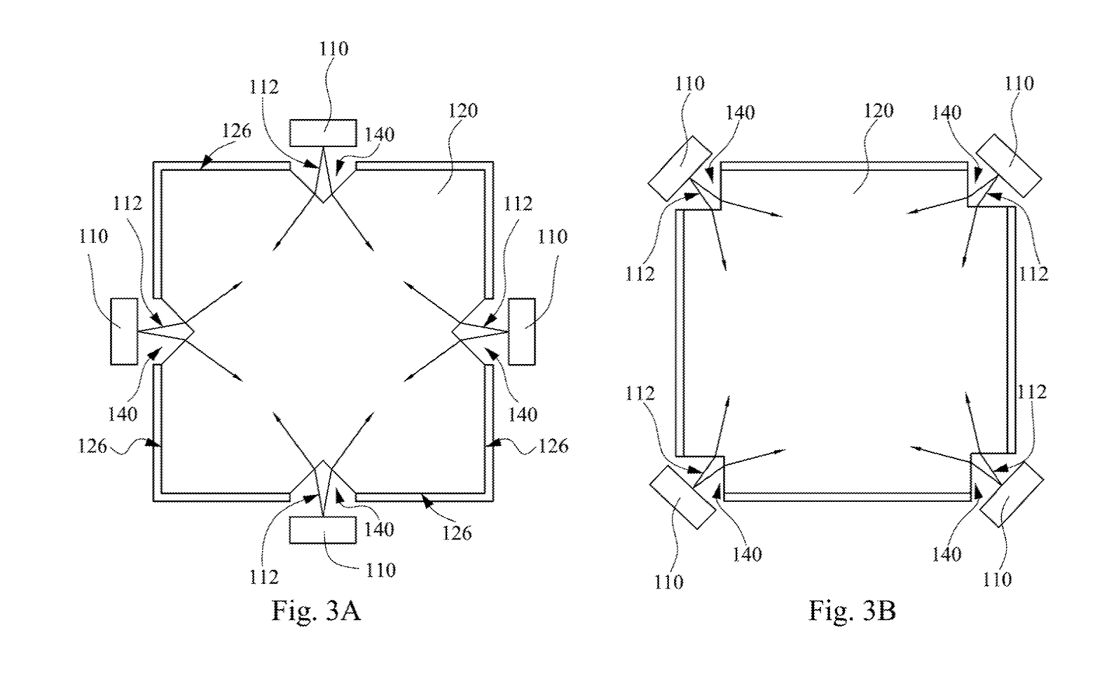

Reference is made to FIG. 4 which is a top view of a laser backlight plate according to the fifth embodiment of the present invention. The difference between the fifth embodiment and the first embodiment pertains to the number of the recesses 140 and the present of guiding elements 150. In this embodiment, the laser backlight plate further includes two guiding elements 150 disposed between the laser source 110 and the recesses 140. The guiding elements 150 which may be fibers or waveguides, are configured for guiding the laser beam 112 to the recesses 140. More specifically, in this embodiment, the laser beam 112 emitted from the single laser source 110 can be guided to the four recesses 140 through the guiding elements 150. This configuration can be applied to an embodiment that the laser source 110 is far away from the light guide plate 120, such as a traffic light, whose light guide plate 120 can be disposed behind the traffic signals, and the laser source 110 can be disposed in the lamppost for replacement convenience. In addition, the light guide plate 120 is a light emitting element, and the laser source 110 has a power which may have leakage of electricity and aging problems that affect the light emitting element. Since the laser source 110 in this embodiment is separated from the light guide plate 120 by the guiding element 150, the leakage of electricity and aging problems can be reduced, thereby enhancing the safety of the laser backlight plate. Other relevant details of the structure of the fifth embodiment are all the same as the first embodiment and, therefore, a description in this regard will not be repeated hereinafter.

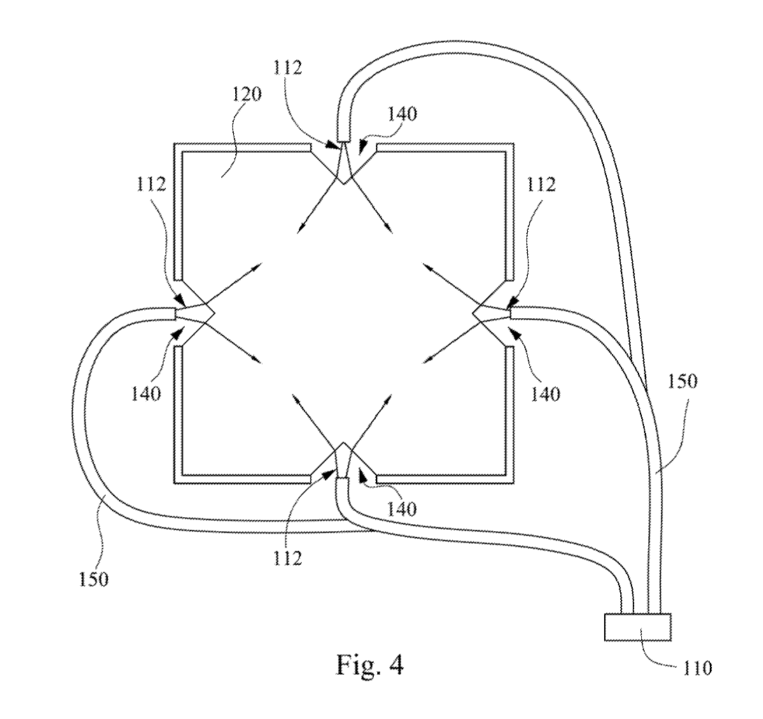

Reference is made to FIG. 5A which is a top view of a laser backlight plate according to the sixth embodiment of the present invention. The difference between the sixth embodiment and the first embodiment pertains to the configuration of the light divergent structure. In this embodiment, the light divergent structure is a diffractive optical element 160, and the diffractive optical element 160 is disposed at the side surface 126 of the light guide plate 120. The diffractive optical element 160 modulates the wave front of the light beam to generate constructive and destructive interferences. Hence, the wave front of the laser beam 112 is changed after the laser beam 112 passes through the diffractive optical element 160. For example, in this embodiment, the laser beam 112 is split into multiple diffractive light beams 114, which propagate toward different directions to diverge the laser beam 112. It is noted that solid arrows in FIG. 5A indicate beam centers of the diffractive light beams 114, and dashed arrows in FIG. 5A indicate beam edges of the diffractive light beams 114.

Reference is made to FIG. 5B which is spatial distribution and intensity distribution diagrams of the diffractive light beams 114 of FIG. 5A, and the intensity distribution diagram indicates the diffractive light beam 114 at Y=0 along X axis. The intensity of the diffractive light beams 114 of the present embodiment is spatial nonuniformity, such as a Gaussian distribution. More specifically, the intensity of the diffractive light beams 114 at the beam center thereof is higher, and becomes lower toward the beam edges. In order to compensate the intensities at the beam edges, two adjacent diffractive light beams 114 overlap. Accordingly, the lower-intensity portions of the diffractive light beams 114 can compensate with each other, resulting in uniform light distribution in the light guide plate 120.

Reference is made again to FIG. 5A. In one or more embodiments, the laser backlight plate can further include an adhering element 170 disposed between the diffractive optical element 160 and the light guide plate 120. The adhering element 170 can be transparent glue configured for attaching the diffractive optical element 160 on the light guide plate 120. In other embodiments, however, the diffractive optical element 160 can be integrated with the light guide plate 120. For example, the diffractive optical element 160 can be carved or imprinted on the light guide plate 120, and the claimed scope of the present invention is not limited in this respect.

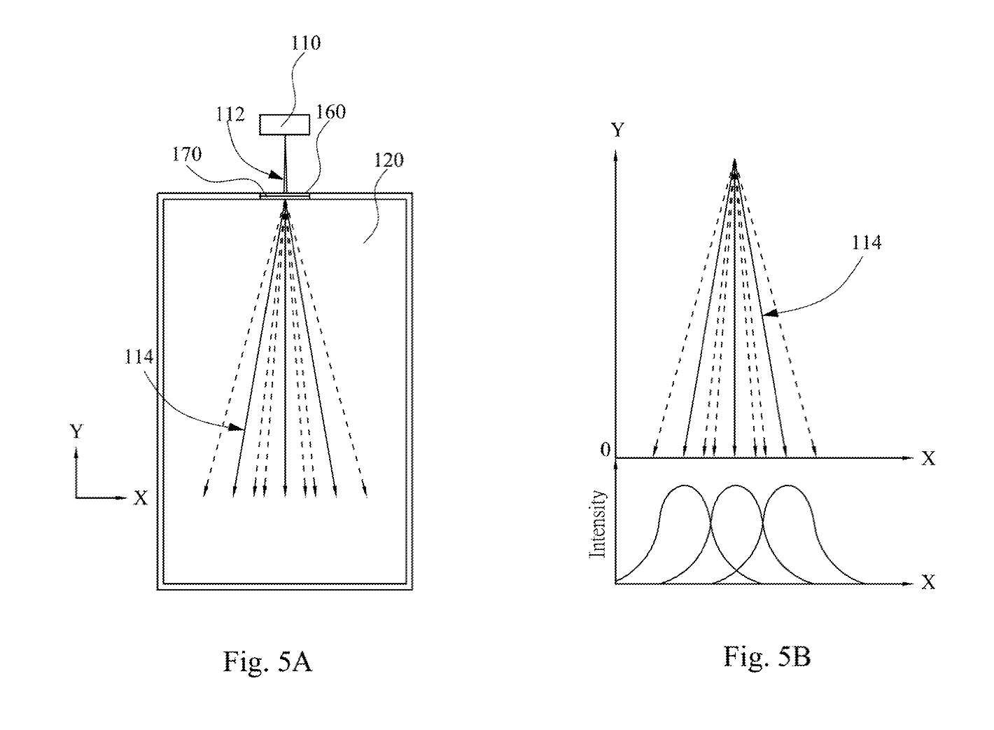

Reference is made to FIG. 6A which is a schematic diagram of the diffractive optical element 160 of FIG. 5A according to one embodiment. In order to diverge the laser beam 112 (see FIG. 5A), the diffractive optical element 160 has a plurality of microstructures 162 arranged periodically to form a phase grating. The wave front of the laser beam 112 can be changed to form diffraction due to height differences of the microstructures 162, such that the laser beam 112 of FIG. 5A can form a plurality of different orders of the diffractive light beams 114 (see FIG. 5A) with different propagation directions after passing through the phase grating.

The configuration of the diffractive optical element 160, however, is not limited in the respect of FIG. 6A. Reference is made to FIG. 6B which is a schematic diagram of the diffractive optical element 160 of FIG. 5A according to another embodiment. In this embodiment, the microstructures 162 are arranged aperiodically. The diffractive optical element 160 can be designed according to the propagation directions and angles of a diffractive light beams. For example, the diffractive optical element 160 may be designed to guide the diffractive light beam toward the backlight surface 124 of the light guide plate 120 (see FIG. 1B) if the backlight surface 124 has micro-particle structures. The arrangement of the microstructures 162 of the diffractive optical element 160 can be designed according to the propagation directions and angles of the diffractive light beams as shown in FIG. 6B. It is noted that the distribution of the microstructures 162 in FIG. 6B are illustrative only, and should not limit the claimed scope of the present invention. A person having ordinary skill in the art may design the distribution of the microstructures 162 according to real requirements. Other relevant details of structure of the sixth embodiment are all the same as the first embodiment and, therefore, a description in this regard will not be repeated hereinafter.

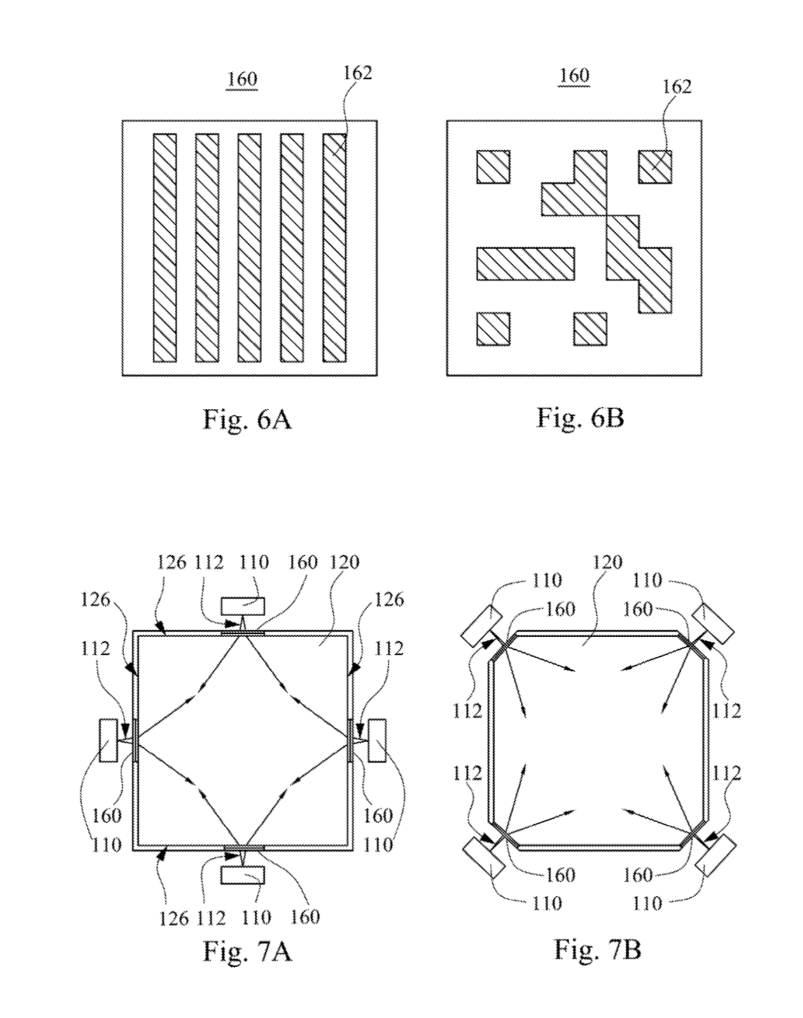

FIGS. 7A and 7B are top views of laser backlight plates according to the seventh and eighth embodiments of the present invention, respectively. The difference between the seventh/eighth embodiment and the sixth embodiment pertains to the numbers of the laser sources 110 and the diffractive optical elements 160. In these two embodiments, the numbers of the laser sources 110 and the diffractive optical elements 160 can be plural to increase the intensity of the laser backlight plate. For example, if the light guide plate 120 is a rectangular plate, the laser sources 110 and the diffractive optical elements 160 can be disposed on four of the side surfaces 126 of the light guide plate 120 as shown in FIG. 7A. Hence, the laser beams 112 can respectively pass through the diffractive optical elements 160 disposed on the four of the side surfaces 126 and enter the light guide plate 120. Moreover, the laser sources 110 and the diffractive optical elements 160 can be disposed on four corners of the light guide plate 120 as shown in FIG. 7B. Hence, the laser beams 112 can respectively pass through the diffractive optical elements 160 disposed at the four corners and enter the light guide plate 120. Therefore, the intensities of the laser backlight plates of the seventh and eighth embodiments are four times the intensity of the laser backlight plate of the sixth embodiment. Other relevant details of structure of the seventh and eighth embodiments are all the same as the sixth embodiment and, therefore, a description in this regard will not be repeated hereinafter.

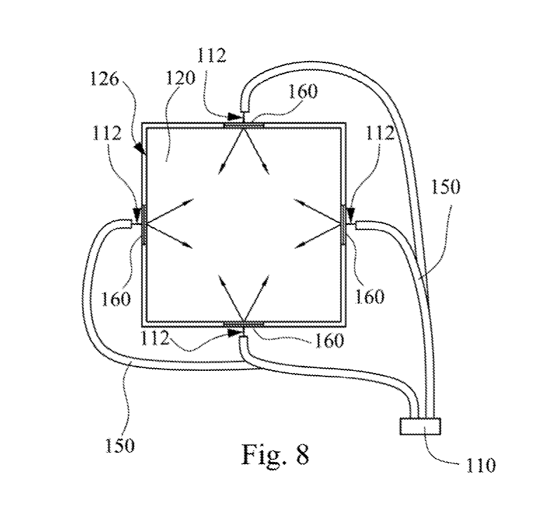

Reference is made to FIG. 8 which is a top view of a laser backlight plate according to the ninth embodiment of the present invention. The difference between the ninth embodiment and the fifth embodiment pertains to the type of the light divergent structures. In this embodiment, the light divergent structures the diffractive optical elements 160. Similarly, the guiding elements 150 can be disposed between the laser source 110 and the diffractive optical elements 160 to guide the laser beam 112 to the four diffractive optical elements 160 when the laser source 110 is far away from the light guide plate 120. Moreover, even though the diffractive optical elements 160 in this embodiment are disposed on the side surfaces 126 of the light guide plate 120, the claimed scope of the present invention is not limited in this respect. In other embodiments, the diffractive optical elements 160 can be disposed at the corners of the light guide plate 120. Other relevant details of structure of the ninth embodiment are all the same as the fifth embodiment and, therefore, a description in this regard will not be repeated hereinafter.

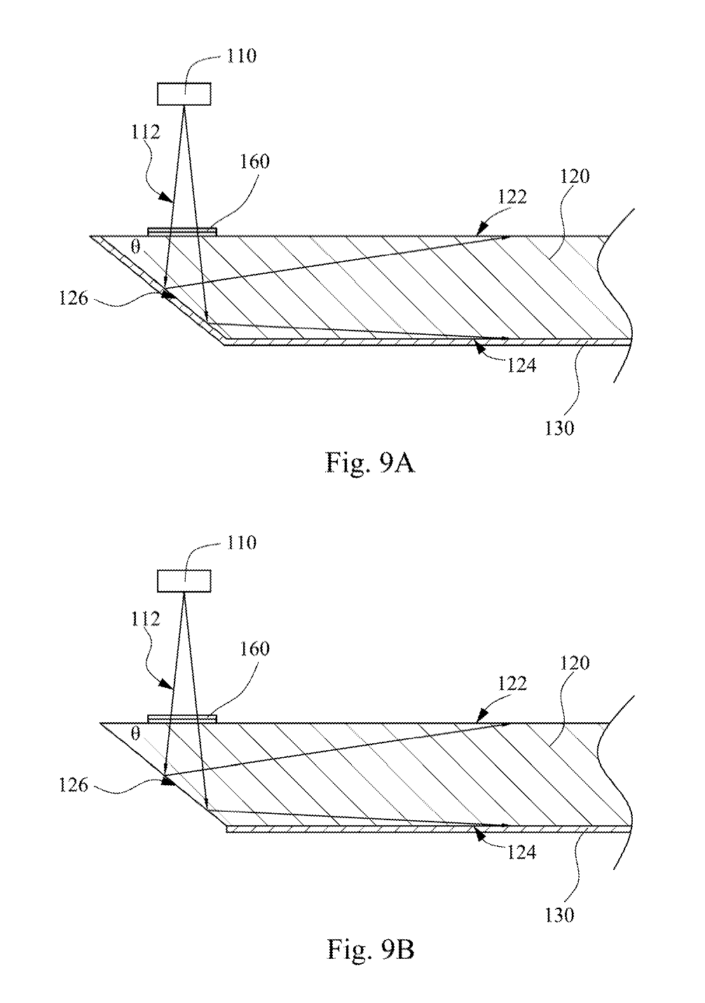

Reference is made to FIGS. 9A and 9B which are cross-sectional views of laser backlight plates according to the tenth and eleventh embodiments of the present invention. The difference between the tenth/eleventh embodiment and the sixth embodiment pertains to the position of the diffractive optical elements 160. In the embodiment of FIG. 9A, an acute angle θ is formed between the light emission surface 122 and the side surface 126. The diffractive optical element 160 is disposed at an end of the light emission surface 122 adjacent to the side surface 126. The laser beam 122 passes through the diffractive optical element 160 and enters the light guide plate 120, and the laser beam 112 propagates in the light guide plate 120 after being reflected by the reflective layer 130 disposed on the side surface 126. However, in the embodiment of FIG. 9B, the reflective layer 130 can expose a portion of the side surface 126. In other words, the reflective layer 130 uncovers the portion of the side surface 126 that is configured for reflecting the laser beam 112. The laser beam 112 of the laser source 110 passes through the diffractive optical element 160 and enters the light guide plate 120, and the laser beam 112 propagates in the light guide plate 120 after being reflected by the exposed side surface 126. The laser beam 112 can be reflected due to the totally internal reflection between the light guide plate 120 and the surrounding medium (i.e., the air in this embodiment).

In general, for a middle- or a small-sized panel, the thickness of the laser backlight plate is thinner, such that the diffractive optical elements 160 is not easy to be carved or be imprinted on the side surface 126 of the light guide plate 120. In the tenth and eleventh embodiments, however, since the area of the light emission surface 122 is greater than that of the side surface 126, the diffractive optical elements 160 is easier to be carved or be imprinted on the light emission surface 122 of the light guide plate 120, such that the laser beam 112 can propagate and be diverged in the light guide plate 120 more efficiently. Other relevant details of structure of the tenth and eleventh embodiments are all the same as the sixth embodiment and, therefore, a description in this regard will not be repeated hereinafter.

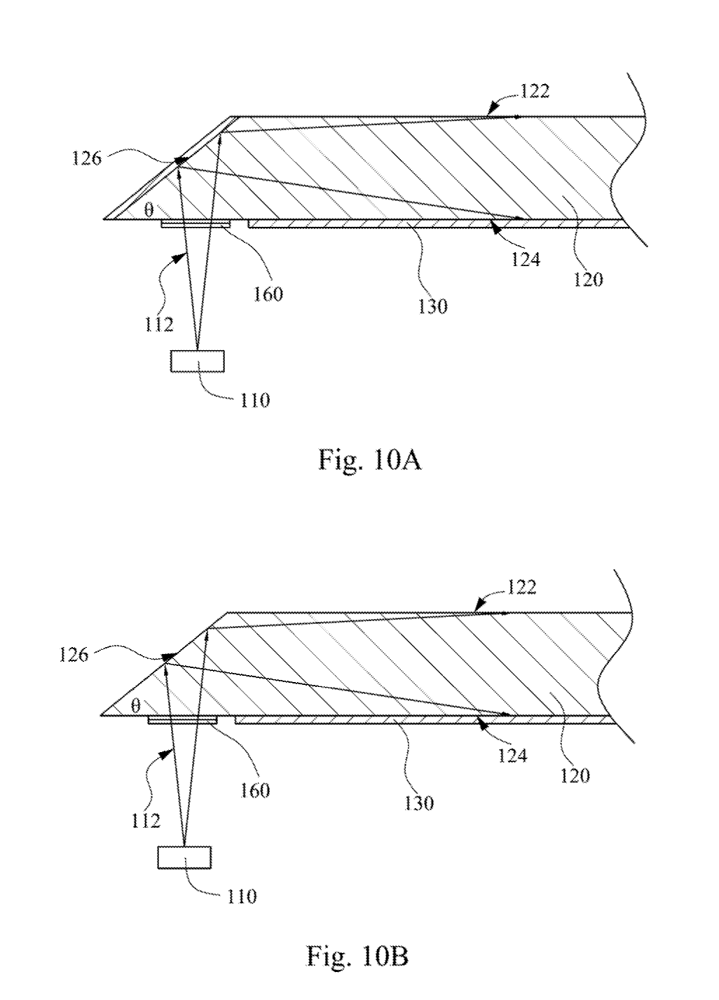

Reference is made to FIGS. 10A and 10B which are cross-sectional views of laser backlight plates according to the twelfth and thirteenth embodiments of the present invention. The difference between the twelfth/thirteenth embodiment and the tenth embodiment pertains to the position of the diffractive optical element 160. In the embodiment of FIG. 10A, an acute angle θ is formed between the backlight surface 124 and the side surface 126. The reflective layer 130 exposes an end of the backlight surface 124 adjacent to the side surface 126, and the diffractive optical element 160 is disposed at the end of the backlight surface 124 adjacent to the side surface 126. That is, the diffractive optical element 160 is disposed on the portion of the backlight surface 124 that is exposed by the reflective layer 130. The laser beam 112 passes through the diffractive optical element 160 and enters the light guide plate 120, and the laser beam 112 propagates in the light guide plate 120 after being reflected by the reflective layer 130 disposed on the side surface 126. However, in the embodiment of FIG. 10B, the reflective layer 130 can expose a portion of the side surface 126. In other words, the reflective layer 130 uncovers the portion of the side surface 126 that is configured for reflecting the laser beam 112. The laser beam 112 of the laser source 110 passes through the diffractive optical element 160 and enters the light guide plate 120, and the laser beam 112 propagates in the light guide plate 120 after being reflected by the exposed side surface 126. The laser beam 112 can be reflected due to the totally internal reflection between the light guide plate 120 and the surrounding medium (i.e., the air in this embodiment), and the claimed scope of the present invention is not limited in this respect.

Similar to the tenth and eleventh embodiments, the laser backlight plate of the present embodiments can be applied to the middle- or small-sized panel. In addition, since the laser source 110 in the twelfth and thirteenth embodiments is disposed outside of the backlight surface 124, the optical output of the laser backlight plate is not affected. Other relevant details of structure of the twelfth and thirteenth embodiments are all the same as the tenth and eleventh embodiments and, therefore, a description in this regard will not be repeated hereinafter.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A laser backlight plate, comprising:
a laser source for providing a laser beam;
a light guide plate having a light emission surface, a backlight surface, and at least one side surface, the backlight surface disposed opposite to the light emission surface, and the side surface extending between the light emission surface and the backlight surface;
at least one reflective layer at least partially covering the backlight surface and the side surface, the reflective layer configured for reflecting the laser beam impinging on the reflective layer to the light emission surface; and
at least one light divergent structure configured for diffusing the laser beam, wherein the laser beam is incident on the light guide plate from the light divergent structure and is reflected to the light emission surface by the reflective layer.

2. The laser backlight plate of claim 1, wherein the light divergent structure is disposed on the side surface of the light guide plate, and the light divergent structure is a recess.

3. The laser backlight plate of claim 2, wherein the recess has a divergent surface, and the divergent surface is a curved surface.

4. The laser backlight plate of claim 1, wherein the light divergent structure is a diffractive optical element.

5. The laser backlight plate of claim 4, wherein the diffractive optical element is disposed on the side surface of the light guide plate.

6. The laser backlight plate of claim 4, wherein an acute angle is formed between the light emission surface and the side surface, the diffractive optical element is disposed at an end of the light emission surface adjacent to the side surface; the laser beam of the laser source passes through the diffractive optical element and enters the light guide plate, and the laser beam propagates in the light guide plate after being reflected by the reflective layer disposed on the side surface.

7. The laser backlight plate of claim 4, wherein an acute angle is formed between the light emission surface and the side surface, the diffractive optical element is disposed at an end of the light emission surface adjacent to the side surface, and the reflective layer exposes a portion of the side surface; the laser beam of the laser source passes through the diffractive optical element and enters the light guide plate, and the laser beam propagates in the light guide plate after being reflected by the exposed side surface.

8. The laser backlight plate of claim 4, wherein an acute angle is formed between the backlight surface and the side surface, the reflective layer exposes an end of the backlight surface adjacent to the side surface, and the diffractive optical element is disposed at the end of the backlight surface adjacent to the side surface; the laser beam of the laser source passes through the diffractive optical element and enters the light guide plate, and the laser beam propagates in the light guide plate after being reflected by the reflective layer disposed on the side surface.

9. The laser backlight plate of claim 4, wherein an acute angle is formed between the backlight surface and the side surface, the reflective layer exposes a portion of the side surface and an end of the backlight surface adjacent to the side surface, and the diffractive optical element is disposed at the end of the backlight surface adjacent to the side surface; the laser beam of the laser source passes through the diffractive optical element and enters the light guide plate, and the laser beam propagates in the light guide plate after being reflected by the exposed side surface.

10. The laser backlight plate of claim 4, wherein the diffractive optical element comprises a plurality of microstructures.

11. The laser backlight plate of claim 10, wherein the microstructures are arranged periodically.

12. The laser backlight plate of claim 1, further comprising at least one guiding element disposed between the laser source and the light divergent structure, the guiding element configured for guiding the laser beam to the light divergent structure.
